(19) United States
(12) Patent Application Publication
(10) Pub. No.: US 2013/0100413 A1
(43) Pub. Date: Apr. 25, 2013

(54) PROJECTION DISPLAY DEVICE

(71) Applicant: Hiroshi Shina, Osaka-shi (JP)

(72) Inventor: Hiroshi Shina, Osaka-shi (JP)

(73) Assignee: SHARP KABUSHIKI KAISHA, Osaka-shi, Osaka (JP)

(21) Appl. No.: 13/807,634

(22) PCT Filed: Feb. 9, 2012
(86) PCT No.: PCT/JP2012/052923

§ 371 Date: Dec. 28, 2012

(30) Foreign Application Priority Data
Feb. 10, 2011 (JP) 2011-026690
Feb. 7, 2012 (JP) 2012-024057

(51) Int. Cl. G02B 27/22; G03B 21/14

(52) U.S. Cl. CPC G02B 27/22; G03B 21/14
USPC 353/7

(57) ABSTRACT

In this projection display device, which can display 3D images, it is possible to support lens shift and zooming without providing excess additional parts and without increasing the number or output of light-emitting elements when mounting a light-emitting element such as an infrared beam light-emitting element to the main body of the projection display device. The projection display device (1) is able to display 3D images, projects from a projection lens (16) light emitted from a light source device (10) with an internal total reflection prism (15), wherein two prisms are disposed facing each other, therebetween, and is provided with an infrared beam light-emitting element (17). The infrared beam light-emitting element (17) is disposed in a manner so that an infrared beam enters the internal total reflection prism (15), the infrared beam is reflected at the internal total reflection surface (15c) of the internal total reflection prism (15), and is projected via the projection lens (16).

### TECHNICAL FIELD

The present invention relates to a projection display device capable of displaying three-dimensional images.

### BACKGROUND OF THE INVENTION

A projection display device, also referred to as a projector, is categorized into a liquid crystal projector, a DLP (digital light processing; registered trade mark, abbreviated below) projector, an LCOS (liquid crystal on silicon) projector, etc.

The DLP projector displays video by using a reflective mirror array element represented by a DMD (digital micromirror device; registered trade mark, abbreviated below) and uses a total internal reflection prism (TIR prism) having two prisms arranged oppositely (see, e.g., Patent Document 1).

On the other hand, to allow visual recognition of three-dimensional moving and still images by using active-shutter glasses in an image displaying apparatus, a timing of switching signals of images for left and right eyes in a frame sequential method must be synchronized with a timing of opening and closing active shutters of left and right eyes in the glasses. If the image displaying apparatus is an apparatus directly displaying an image on a display panel, infrared communication, radio communication in another frequency band, and wired communication can be used for this synchronization.

For a liquid crystal projector, a technique is known that automatically adjusts a focus of a projection lens by projecting detecting projection light to detect light reflected from screen (see, e.g., Patent Document 2). In the technique described in Patent Document 2, in an optical system made up of a transmission type panel made up of an LCD (liquid crystal display) for light modulation with three primary colors, a prism (or mirror) combining lights emitted from LCDs of respective colors, and a transmission lens expanding and projecting the combined light to a screen, a semitransparent reflection film means is disposed between the prism (or mirror) and the projection lens to cause the output of the detecting projection light from a light-emitting portion disposed separately from the LCD to be projected via the projection lens toward the screen, and the reflection light from the screen is also detected via the semitransparent reflection film means and the projection lens and used for focus adjustment.

### PRIOR ART DOCUMENT

### Patent Document

Patent Document 1: Japanese Laid-Open Patent Publication No. 2009-20424
Patent Document 2: Japanese Laid-Open Patent Publication No. 11-119184

### SUMMARY OF THE INVENTION

### Problems to be Solved by the Invention

As described above, in the case of the image displaying apparatus directly displaying, and allowing visual recognition of, an image on a display panel, the opening and closing of active shutters can be controlled by a communicating means regardless of whether wireless or wired.

However, if the image displaying apparatus is of the projection type, preferably, an infrared transmitting portion having an infrared light-emitting element is included in a main body of the apparatus to project infrared light from the infrared transmitting portion on to a screen to which video is projected, and the infrared light reflected therefrom is used for synchronization. Reasons for using reflection in this way include that, since a projection display device is based on the premise that a viewer watches video on a screen, it is most effective and highly convenient if infrared light is emitted from inside the screen and a light receiving portion of glasses is directed toward the video, and that costs can be reduced as compared to disposing a separate transmitter in the vicinity of the screen.

FIG. 10 is a schematic of a configuration improved such that an infrared transmitting portion for allowing stereoscopic view of images by using active-shutter glasses in a projection display device according to a conventional technique. A projection display device (3D projector) 100 capable of displaying three-dimensional images depicted in FIG. 10 includes a light source device 10, a color wheel 11 time-dividing light emitted from the light source device 10 into three colors of red, green, and blue, a rod integrator 12 causing total internal reflection of light incident via the color wheel 11 to emit the light with uniform illumination distribution, a condenser lens 13 having a plurality of lenses for condensing the light emitted from the rod integrator 12, a DMD 14, a TIR prism 15 having two triangular prisms 15a and 15b arranged oppositely, and a projection lens 16 projecting the outgoing light from the TIR prism 15 to a screen S. The TIR prism 15 has an internal reflection surface (boundary surface) 15c reflecting the outgoing light from the condenser lens 13 and making the light incident on the DMD 14. The TIR prism 15 allows light that is the incident light reflected by the DMD 14 to pass through the internal reflection surface 15c, emitting the light to the projection lens 16.

Although video projected from the projection lens 16 can be viewed with 3D compatible glasses G having active shutters, the opening and closing of the active shutters of right and left eyes must be synchronized with the video as described above. Therefore, infrared light-emitting elements are disposed separately from a projection optical system in a main body of the 3D projector 100.

In FIG. 10, the 3D projector 100 has a lens shift function and, therefore, infrared light-emitting elements 101_{C}, 101_{L}, and 101_{R} are disposed at three locations separately from the projection optical system as depicted. The infrared light-emitting elements 101_{C} are normally used elements disposed correspondingly to an image position without a lens shift, projecting an infrared image S_{iC} in a portion of an image S on the screen. The infrared light-emitting elements 101_{L} are elements disposed correspondingly to an image position at the time of the lens shift to the left, projecting an infrared image S_{iL} in a portion of an image S_{L} (the right end of the image S_{L} is not depicted). The infrared light-emitting elements 101_{R} are elements disposed correspondingly to an image position at the time of the lens shift to the right, projecting an infrared image Sᵢᵣ in a portion of an image S_{R} (the left end of the image S_{R} is not depicted). The glasses G receive one infrared image emitted from any one location depending on a shift position with a light receiving portion and controls the opening and closing of the left and right active shutters based on (a change in) the intensity of the infrared light, i.e., a pulse of the infrared light.

To synchronize 3D images and the active-shutter glasses to allow a viewer to stereoscopically view the images, an infrared transmitting portion must be mounted on a main body of a projection display device as described above, and this causes the following problems. The usage of ultraviolet light or visible light instead of infrared light naturally causes basically the same problems.

(1) The infrared transmitting portion is attached to a side surface etc., of the apparatus main body, and imposes a limitation on internal layout and design.

(2) Since the reflection from the screen is utilized, delicate setup is needed such as adjusting directionality of infrared light to the screen.

(3) Since the infrared transmitting portion itself has broad angle characteristics and the sensitivity deteriorates as a distance between the screen and the apparatus increases, therefore a lack of the sensitivity must be compensated. Therefore, it is necessary to increase the output of the infrared light-emitting element, to dispose a lens for the infrared light-emitting element different from a lens for images, or to increase the number of the infrared light-emitting elements as is the case with the infrared light-emitting elements 101_{L}, 101_{C}, and 101_{R} disposed as a set of three elements at each location.

(4) If a zoom lens is used as a projection lens projecting images, a distance varies between the wide side and the telescopic side and, therefore, the disposition condition of the infrared light-emitting element becomes complicated.

(5) If the projection display device has a lens shift function, a positional relationship is adjustable between a projected image and the screen and, therefore, infrared light must be directed in broader direction while directionality must be maintained at a certain level so as to keep high sensitivity. Therefore, as indicated by the infrared light-emitting elements 101_{L}, 101_{C}, and 101_{R} at three locations in FIG. 10, the infrared light-emitting elements must separately be disposed in arrangement enabling the projection to an image position corresponding to a lens shift.

Even if the technique described in Patent Document 1 is applied such that infrared light is included in the detecting projection light so as to solve the problems as described in (1) to (5), the following problems are newly caused. The usage of ultraviolet light or visible light instead of infrared light naturally causes basically the same problems.

(6) As compared to a general optical system without the need to output infrared light, additional components are necessary including a semitransparent reflection film means such as a prism and a mirror, and auxiliary components for holding the means, and the costs and apparatus size are increased.

(7) A distance from an LCD panel to a projection lens, i.e., a back focal distance is also elongated to ensure a space for inserting the additional components. As a result, since greater positive and negative powers are necessary in projection lens design, the number of lenses is increased, leading to increase in cost and apparatus size.

(8) The additional components also increase a reflection or transmission loss, deteriorating the optical output of projected images. Although a mirror is an inexpensive additional component, an obliquely inserted parallel plate causes astigmatism, deteriorating imaging performance.

(9) If 3D compatible and 3D incompatible projection display devices are manufactured by using a common platform, the 3D incompatible projection display device also requires the additional components and the projection lens using a large number of lenses, bearing a burden of extra costs.

The present invention was conceived in view of the situations and it is therefore an object of the present invention to enable a project type displaying apparatus capable of displaying three-dimensional images to support a lens shift and zooming when a light-emitting element such as an infrared light-emitting element is mounted on a main body of the projection display device, without increasing the number and output of the light-emitting element and without disposing an unnecessary additional component.

### Means for Solving the Problem

To solve the above problems, a first technical means of the present invention is a projection display device capable of displaying three-dimensional images comprising: a total internal reflection prism having two prisms arranged oppositely; and a projection lens, the projection display device causing light emitted from a light source to be projected via the total internal reflection prism from the projection lens, the projection display device further comprising a light-emitting element, the light-emitting element being disposed to make a light beam incident on the total internal reflection prism such that the light beam is reflected by an internal reflection surface of the total internal reflection prism and projected via the projection lens.

A second technical means of the present invention is the projection display device of the first technical means, wherein the light-emitting element is disposed relative to the total internal reflection prism such that the light beam is incident on a surface different from an incident surface of the light emitted from the light source and an outgoing surface toward the projection lens.

A third technical means of the present invention is the projection display device of the first technical means, further comprising a reflective mirror array element, wherein the light emitted from the light source is projected via the reflective mirror array element and the total internal reflection prism from the projection lens.

A fourth technical means of the present invention is the projection display device of the third technical means, wherein the light-emitting element is disposed relative to the total internal reflection prism such that the light beam is incident on a surface different from an incident surface of the light emitted from the light source, an incident surface of the light reflected by the reflective mirror array element, and an outgoing surface toward the projection lens.

A fifth technical means of the present invention is the projection display device of any one of the first to the fourth technical means, wherein the light-emitting element is a light-emitting diode.

A sixth technical means of the present invention is the projection display device of any one of the first to the fourth technical means, wherein the light-emitting element is a laser element.

A seventh technical means of the present invention is the projection display device of any one of the first to the sixth technical means, wherein the light-emitting element has a half-value angle corresponding to an effective capture angle indicted by an F-value of the projection lens.

An eighth technical means of the present invention is the projection display device of any one of the first to the seventh technical means, wherein the light beam projected from the projection lens and reflected by a projected surface is used for opening and closing active shutters in active-shutter three-dimensional image viewing glasses.

A ninth technical means of the present invention is the projection display device of any one of the first to the eighth technical means, wherein the light-emitting element is an infrared light-emitting element or an ultraviolet light-emitting element, and wherein the total internal reflection prism has an antireflection film for visible light disposed on the internal reflection surface.

### Effect of the Invention

According to the present invention, the project type displaying apparatus capable of displaying three-dimensional images can support a lens shift and zooming when the light-emitting element such as an infrared light-emitting element is mounted on the main body of the projection display device, without increasing the number and output of the light-emitting element and without disposing an unnecessary additional component.

### BRIEF DESCRIPTION OF DRAWINGS

FIG. 1 is a schematic of an exemplary configuration of a projection display device according to the present invention.

FIG. 2 is a diagram for explaining a lens shift using a TIR prism.

FIG. 3 is a pattern diagram of a positional relationship between a diaphragm and illuminating light in the state depicted in FIG. 2.

FIG. 4 is a diagram for explaining a lens shift when the TIR prism is not used.

FIG. 5 is a pattern diagram of a positional relationship between a diaphragm and illuminating light in the state depicted in FIG. 4.

FIG. 6 is a diagram of an example of frequency characteristics of an antireflection film disposed on an internal reflection surface in the TIR prism of FIG. 1.

FIG. 7 is a schematic of another exemplary configuration of the projection display device according to the present invention.

FIG. 8 is a schematic of yet another exemplary configuration of the projection display device according to the present invention.

FIG. 9 is a schematic of a further exemplary configuration of the projection display device according to the present invention.

FIG. 10 is a schematic of a configuration improved such that an infrared transmitting portion for allowing stereoscopic view of images by using active-shutter glasses in a projection display device according to a conventional technique.

### PREFERRED EMBODIMENT OF THE INVENTION

A projection display device according to the present invention is characterized in that a main body thereof includes a light-emitting element. The present invention will hereinafter be described by taking an example of using an infrared light-emitting element emitting infrared light, i.e., invisible light. However, such a light-emitting element is not limited to infrared light, and even if an element emits ultraviolet light, which is another example of invisible light, or visible light, the element is also applicable as long as the element emits a light beam in a band different from the spectrum of projection light actually projected as video from the projection display device.

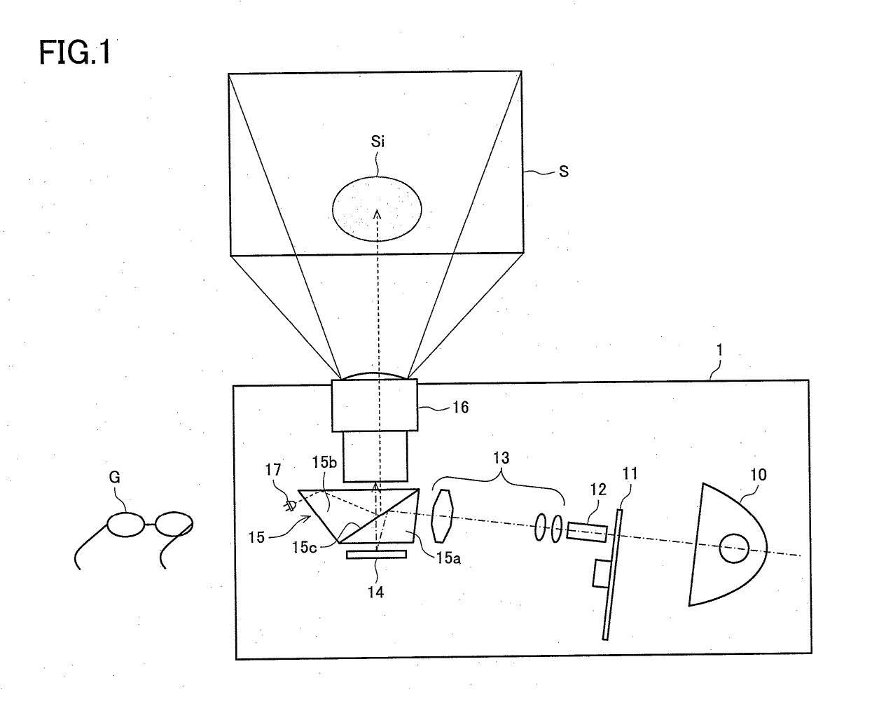

FIG. 1 is a schematic of an exemplary configuration of a projection display device according to the present invention; in FIG. 1, reference numeral 1 denotes a projection display device compatible with three-dimensional image display (hereinafter, simply referred to as a “3D projector”) according to the present invention; S denotes an image projected on a screen; and G denotes 3D compatible glasses.

The 3D projector 1 includes a light source device 10, a color wheel 11, a rod integrator 12, a condenser lens 13, a reflective mirror array element (hereinafter, DMD) 14 represented by a DMD, a TIR prism 15, and a projection lens 16, and is an apparatus causing the light emitted from the light source device 10 to be projected via the DMD 14 and the TIR prism 15 from the projection lens 16. The 3D projector 1 can project and display 3D images in addition to normal 2D images.

The light source device 10 may be configured to include a high-intensity lamp such as a metal halide lamp and an extra high pressure mercury lamp, for example. The color wheel 11 includes filters of three primary colors of red, green, and blue, and is configured such that the filters rotate at high speed so as to time-divide the light emitted from the light source device 10 into three colors of red, green, and blue. The color wheel 11 may be configured to include a colorless transparent portion or a yellow filter so as to increase brightness.

The rod integrator 12 and the condenser lens 13 are disposed between the light source device 10 and the DMD 14. The rod integrator 12 causes total internal reflection of light incident via the color wheel 11 to emit the light with uniform illumination distribution. The condenser lens 13 is a lens group condensing the light emitted from the rod integrator 12 and emitting the light to the TIR prism 15.

The DMD 14 is a display element having micro mirror surfaces (micromirrors) corresponding to the number of pixels arranged on a flat surface. The DMD 14 receives the light reflected by an internal reflection surface (boundary surface) 15c of the TIR prism 15 described later, forms an image from the reflected light, and returns the image to the TIR prism 15 by driving the individual mirrors with a control portion not depicted in accordance with a pixel signal. The DMD 14 can reflect images of respective colors in accordance with sequential signals of red, green, and blue synchronized with the high-speed rotation of the color wheel 11 to return a color image to the TIR prism 15.

The TIR prism 15 has two triangular prisms 15a and 15b arranged oppositely such that the internal reflection surface (boundary surface) 15c only allows passage of light incident at an angle smaller than a predetermined incident angle and totally reflects the rest. The internal reflection surface 15c is disposed on a portion in which the oblique side surfaces of the two triangular prisms 15a and 15b are joined. The internal reflection surface 15c may have a layer with a lower refraction index formed by an air layer, for example. More specifically, an air layer of a minute space may be formed by disposing a spacer formed by vacuum deposition of metal or dielectric on facing surfaces, or a convex portion may be disposed around the entire circumferential edge on the facing surface of one triangular prism to define a concave portion in a portion other than the circumferential edge so that the air layer is formed. A critical angle can be determined depending on a ratio of refraction index between a layer with a lower refraction index formed in this way and the triangular prisms 15a and 15b.

The TIR prism 15 is disposed such that the outgoing light from the condenser lens 13 is reflected by the internal reflection surface 15c and incident on the DMD 14 and that the incident light reflected by the DMD 14 and incident on the TIR prism 15 passes through the internal reflection surface 15c and exits to the projection lens 16. The projection lens 16 is a lens receiving and projecting the outgoing light from the TIR prism 15 to the screen. Images projected from the projection lens 16 to the screen are red, green, and blue images sequentially reflected by the DMD 14 at high speed, resulting in a color image.

The present invention is mainly characterized in that the 3D projector 1 is disposed with an infrared light-emitting element 17. Particularly in the present invention, the infrared light-emitting element 17 is disposed as a part of a projection optical system as depicted in FIG. 1. More specifically, the infrared light-emitting element 17 is disposed such that infrared light is incident on the TIR prism 15 and that the infrared light is reflected by the internal reflection surface 15c of the TIR prism 15 and projected via the projection lens 16. Not only the disposition of the TIR prism 15 relative to the condenser lens 13 and the projection lens 16 but also a critical angle etc., of the internal reflection surface 15c may be determined such that the infrared light and the light from the light source can follow optical paths described herein (preferably, optical paths as depicted in FIG. 1).

As a result, an infrared image Sᵢ is projected in a portion of an image S on the screen. The infrared image may be, for example, an image defined as a circle or a rectangle only in a screen center portion as depicted, and an image in another shape may naturally be employed regardless of size.

If an image (moving image or still image) projected from the projection lens 16 is a 3D image, the image is viewed by a viewer with the active-shutter 3D compatible glasses G. In this case, the opening and closing of the active shutters for right and left eyes must be synchronized with the image so as to allow visually recognition as a 3D image. Therefore, a signal of infrared light emitted from the infrared light-emitting element 17 and reflected on the screen is used for opening and closing the active shutters of the 3D compatible glasses G.

More specifically, a frame sequential method of alternatively displaying left eye video and right eye video for each time period may be used for the output of image signals, and the active-shutter glasses may be used as dedicated glass to open only the left eye glass by opening the left eye active shutter of the glasses and closing the right eye active shutter while the 3D projector 1 outputs the left eye video and to open only the right eye glass in contrast while the 3D projector 1 outputs the right eye video. The infrared light output from the infrared light-emitting element 17 may be a pulse signal synchronized with a left eye frame and a right eye frame. The infrared light may more simply be output as an ON signal at the time of the left eye frame and an OFF signal at the time of the right eye frame, for example. The 3D compatible glasses G may receive the infrared light reflected from the screen, determine ON/OFF of the pulse signal based on the intensity of the received infrared light, and control the opening and closing of the left and right active shutters based on this determination result.

Since the infrared light output from the infrared light-emitting element 17 is projected from the TIR prism 15 via the projection lens 16 to the screen as is the case with the route of the 3D image as described above, a lens shift and zooming can be supported.

As described above, the 3D projector 1 of the present invention is configured without an additional component by utilizing the TIR prism 15 originally disposed for the purpose of dividing illumination light and imaging light to achieve an image displaying function in a DMD type 3D projector and can therefore solve the problems (1) to (9) described above. In other words, since the projection lens 16 and the TIR prism 15 originally included are utilized in the 3D projector 1, the internal layout and the exterior design are not affected. Since the infrared light is output from the projection lens 16 in the 3D projector 1 and is therefore always matched with the place at which an image is projected, the stable operation of the 3D compatible glasses is expected without being affected by the wide side and the telescopic side of a zoom lens when a zoom function is implemented and a position of a lens shift when a lens shift function is implemented. Since the 3D projector 1 allows the infrared light to efficiently arrive at a small area of the screen, the output and the number of the infrared light-emitting elements 17 can be reduced as compared to the conventional case.

As described above, according to the present invention, when the infrared light-emitting element 17 is mounted on the main body, a lens shift and zooming can be supported without increasing the number and output of the infrared light-emitting element 17 and without disposing an unnecessary additional component.

In the exemplary configuration described above, as depicted in FIG. 1, the infrared light is made incident on a surface not originally used for projecting an image in the DLP projector using the TIR prism 15 and is reflected by the internal reflection surface 15c and projected by the projection lens 16 for displaying a projection image to the screen.

Therefore, the infrared light-emitting element 17 is disposed relative to the TIR prism 15 such that the infrared light is incident on a surface different from an incident surface of the light emitted from the light source device 10, an incident surface of the light reflected by the DMD 14, and an outgoing surface toward the projection lens 16. As described above, the present invention allows the infrared light to be reflected by the internal reflection surface 15c. Therefore, in this exemplary configuration, the infrared light made incident on the TIR prism 15 is reflected by the inner side of the outgoing surface toward the projection lens 16, is then reflected by the internal reflection surface 15c, and exits from the outgoing surface toward the projection lens 16.

Such an exemplary configuration is preferable since the infrared light-emitting element 17 is not located at a position blocking the input of images. Although the infrared light-emitting element 17 may naturally be disposed such that the infrared light is made incident on another surface such as the outgoing surface toward the projection lens 16, however, costs are somewhat increased because the TIR prism 15 must be increased in size, as compared to the preferably disposed exemplary configuration depicted in FIG. 1.

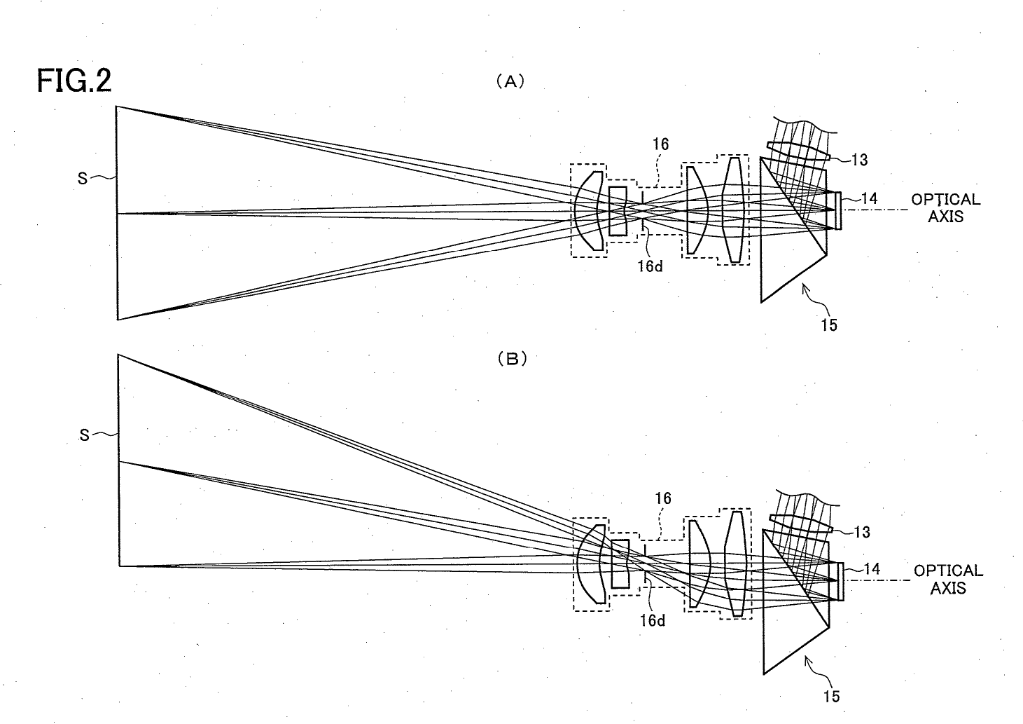

Since the infrared light is projected from the TIR prism 15 via the projection lens 16 to the screen as is the case with the route of the 3D image as described above, a lens shift can be supported. Actually, in addition to this point, if the lens shift function is implemented in a projector using a DMD, an optical system using the TIR prism 15 must basically be used as depicted in FIG. 1. A movement mechanism for the lens shift must obviously be disposed. This will be described with reference to FIGS. 2 to 5.

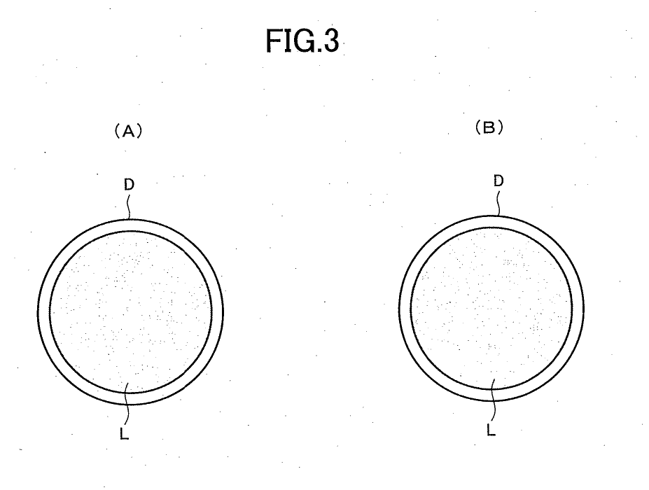

The case of using a TIR prism to implement the lens shift function will be described with reference to FIGS. 2 and 3. FIG. 2 is a diagram for explaining a lens shift using a TIR prism and FIGS. 2(A) and 2(B) are diagrams of a state of an optical path before the lens shift and a state of an optical path after the lens shift, respectively. FIGS. 3(A) and 3(B) are pattern diagrams of a positional relationship between a diaphragm and illuminating light in the states depicted in FIGS. 2(A) and 2(B), respectively.

FIGS. 2(A), 2(B) depict respective optical paths when the projection lens 16 is disposed at a position A (defined as a normal position) and a position B due to a lens shift using the TIR prism. As indicated by transition from the state of FIG. 2(A) to the state of FIG. 2(B), while the positions of an illuminating optical system of the condenser lens 13 etc., the DMD 14, and the TIR prism 15 are fixed to the main body of the 3D projector 1, the position of the projection image S (as well as the position of the infrared image) can be changed by sliding and moving the position of the projection lens 16 in a direction perpendicular to the optical axis by the movement mechanism.

It is important in this case that the design is made in advance such that the projection lens 16 is telecentric on the side of the DMD 14 while the illuminating light also becomes telecentric after reflected by the DMD 14 so as to be efficiently made incident on the projection lens 16. Even when the projection lens 16 is moved in this state, a main light beam (parallel to the optical axis in this case) always passes through the center of a diaphragm 16d and, therefore, the light beam is not blocked.

Describing this point by reference to a state of illuminating light L in a cross section D of the diaphragm 16d, the illuminating light L is within the cross section D of the diaphragm at the both positions A and B as described in FIGS. 3(A) and 3(B) and the light is efficiently allowed to pass through.

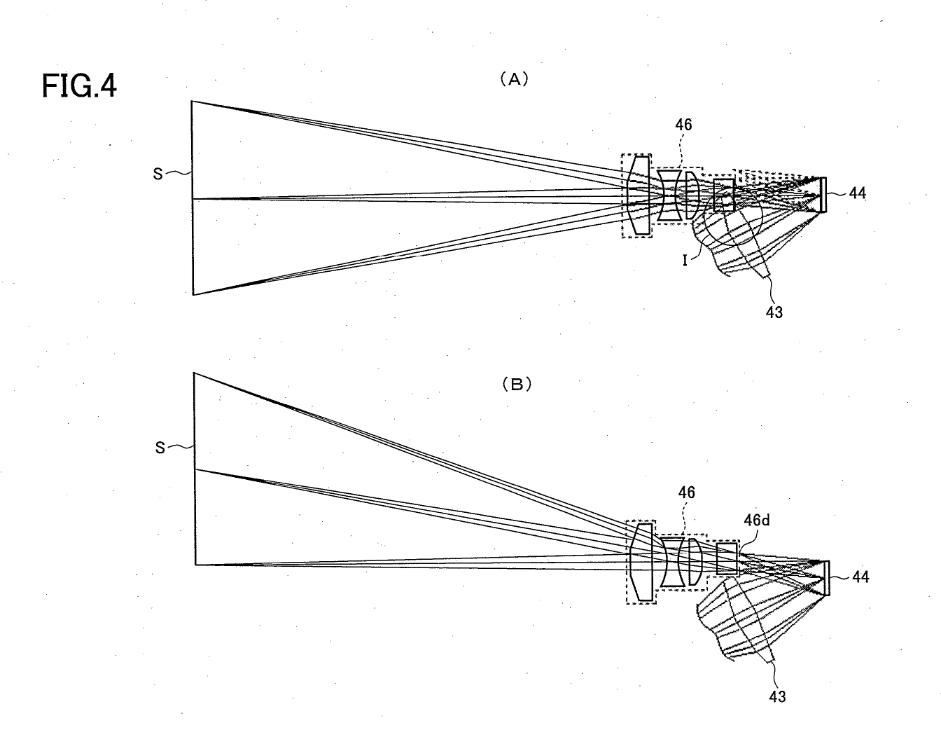

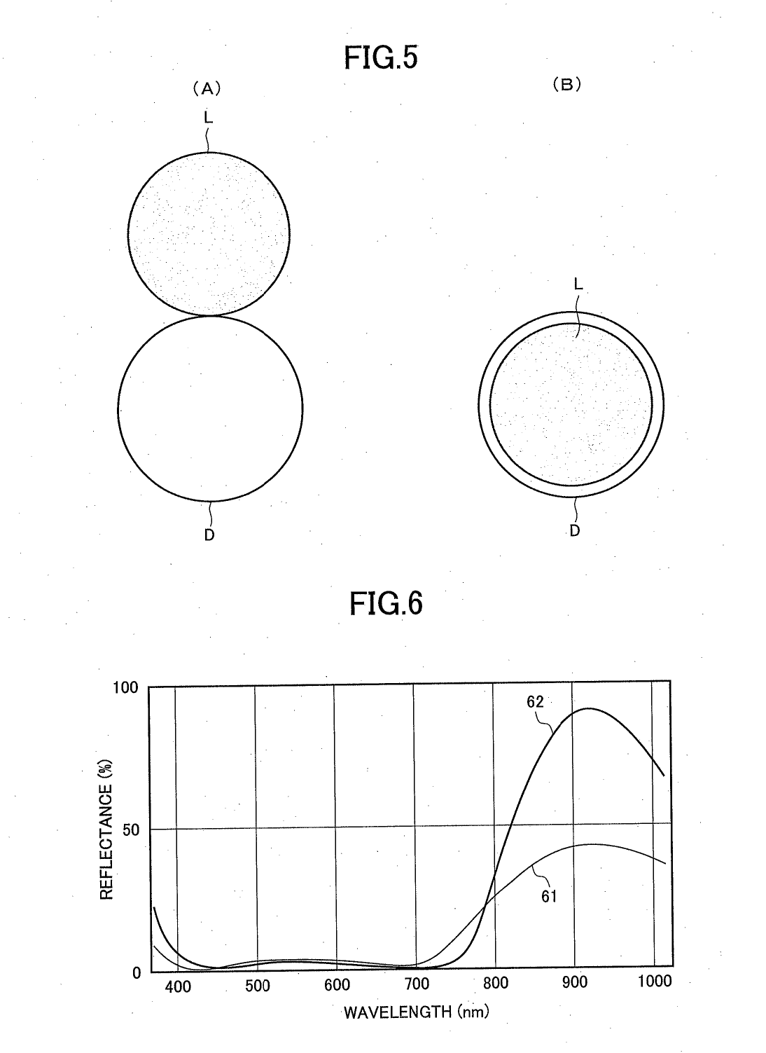

In contrast, it is difficult to implement the lens shift function in an optical system not using a TIR prism. This will be described with reference to FIGS. 4 and 5. FIG. 4 is a diagram for explaining a lens shift when the TIR prism is not used and FIGS. 4(A) and 4(B) are diagrams of a state of an optical path before the lens shift and a state of an optical path after the lens shift, respectively. FIGS. 5(A) and 5(B) are pattern diagrams of a positional relationship between a diaphragm and illuminating light in the states depicted in FIGS. 4(A) and 4(B), respectively.

FIGS. 4(A) and 4(B) depict respective optical paths when a projection lens 46 is disposed at a position A and a position B (defined as a normal position) due to a lens shift not using a TIR prism. In an optical system at the position B, a diaphragm 46d of the projection lens 46 is designed to be located near a lens closest to a DMD 44 and an illuminating system is also designed in advance to concentrate light to the diaphragm 46d. As a result, the systems are established without interference of the illuminating light and a lens of the illuminating optical system, i.e., without interference of light beams and components. In a normal design, a convex lens (or a concave mirror similarly having a positive power) is disposed near the diaphragm 46d as depicted in FIG. 4(B).

In the state as depicted in FIG. 4(B), while the positions of an illuminating optical system of a condenser lens 43 etc., and the DMD 44 are fixed to a main body of a 3D projector, if it is attempted to change the position of the projection image S by sliding and moving the position of the projection lens 46 in a direction perpendicular to the optical axis by the movement mechanism, the movement of the projection lens 46 to the position A as depicted in FIG. 4(A) causes interference as depicted in a portion indicated by an area I because the illuminating light and the lens (concave mirror) of the illuminating optical system are fixed and, therefore, the systems are not established.

Even if the interference of components is prevented by unreasonable design, since the illuminating system and the DMD 44 are fixed, the reflected light from the DMD 44 travels as indicted by broken lines of FIG. 4(A) and cannot efficiently pass through the diaphragm (46d).

Describing this point by reference to a state of illuminating light L in a cross section D of the diaphragm 46d, as described in FIGS. 5(A) and 5(B), the illuminating light L is within the cross section D of the diaphragm at the position B while the illuminating light L is out of the cross section D of the diaphragm at the position A, making the passage of light impossible.

As described above, if no TIR prism is equipped, the lens shift function is difficult to implement. In other words, to achieve the lens shift function in a 3D projector using a DMD, the optical system using the TIR prism may be used and, therefore, the optical system using the TIR prism is inevitably employed.

The reflection of infrared light by the internal reflection surface 15c will be described. As described with reference to FIGS. 1 to 3, the infrared light-emitting element 17 is disposed as a part of the projection optical system in the present invention and, in this case, the reflectance characteristics of the TIR prism 15 are important. The reflectance characteristics will be described with reference to FIG. 6. FIG. 6 is a diagram of an example of frequency characteristics of an antireflection film disposed on an internal reflection surface in the TIR prism of FIG. 1.

Visible light returns toward the DMD 14 as can be seen by following the light beam backward from the screen in FIG. 1. However, even when a normal antireflection film for visible light is applied as coating etc., to the internal reflection surface 15c, only a film thickness and the number of layers are designed so as to reduce the reflectance for a visible light band (wavelength on the order of 400 nm to 700 nm) and no design is intentionally made particularly for the other bands. More specifically, as depicted in frequency characteristics of reflectance of glass with a normal antireflection film for visible light applied in a graph 61 of FIG. 6, since infrared light is reflected, the optical system described in FIG. 1 can be established even when only the normal antireflection film for visible light is applied to the internal reflection surface 15c.

As described above, the TIR prism 15 is preferably disposed with an antireflection film for visible light on the internal reflection surface 15c. As a result, while functioning as a reflection film for infrared light, the antireflection film can substantially prevent the reflection of visible light when the incident angle is smaller than a predetermined angle.

The antireflection film applied to the internal reflection surface 15c acts as a reflection film for the emitted infrared light and, preferably, the antireflection film is configured to increase the reflectance for the emitted infrared light, i.e., the antireflection film is a film having a capability of increasing the reflectance for the emitted infrared light. More specifically, a film may specially be designed such that the antireflection film is configured to have reflectance-frequency characteristics with increased reflectance for infrared light (assumed to have a wavelength of 900 nm in this case) as depicted in a graph 62 of FIG. 6.

To efficiently project infrared to the screen, the transmissivity of the projection lens 16 for infrared light is also important. Since the projection lens 16 includes a large number of lenses, a normal antireflection film for visible light is of no use because the transmissivity is reduced. However, if a film is designed for the projection lens 16 in consideration of infrared as is the case with the internal reflection surface 15c (particularly so that the characteristics indicated by the graph 62 are given), the transmissivity can easily be increased.

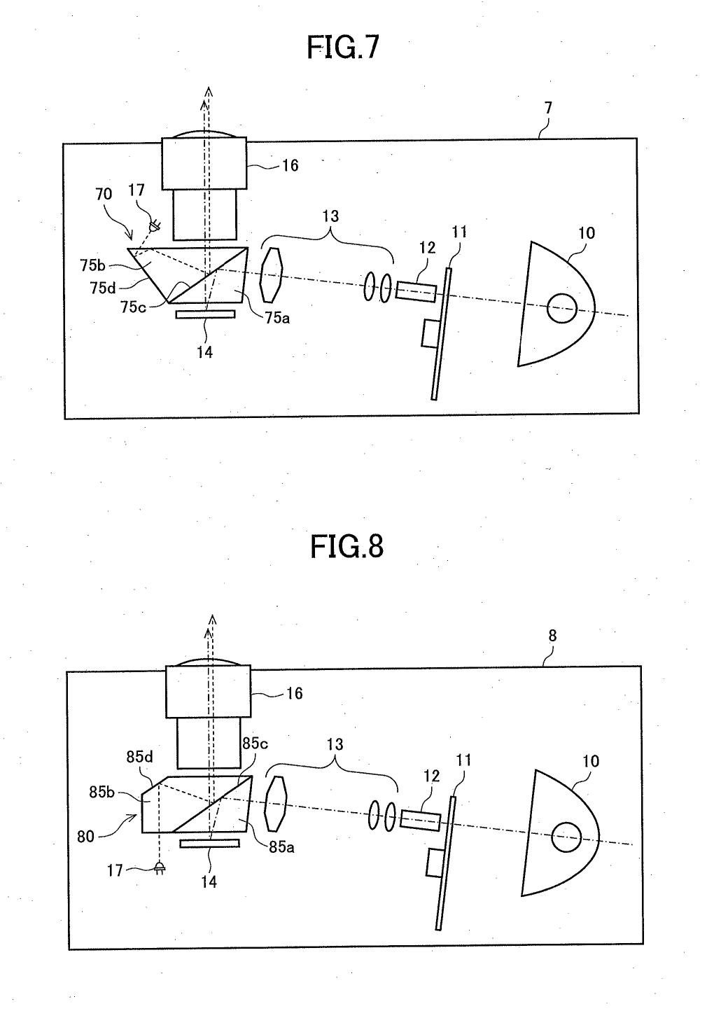

The projection display device according to the present invention is not limited to the configuration including the TIR prism 15 as depicted in FIG. 1 and, for example, exemplary configurations as depicted in FIGS. 7 and 8 are also employable. FIGS. 7 and 8 are schematics of other exemplary configurations of the projection display device according to the present invention and, in FIGS. 7 and 8, reference numeral 7 and 8 denote a 3D projector. The 3D projectors 7 and 8 will hereinafter basically be described in terms only of differences from the 3D projector 1 of FIG. 1.

As depicted in FIG. 7, the 3D projector 7 has a TIR prism 70. The TIR prism 70 has a triangular prism 75a same as the triangular prism 15a of the TIR prism 15 of FIG. 1 and a triangular prism 75b arranged oppositely, and an internal reflection surface (boundary surface) 75c thereof only allows passage of light incident at an angle smaller than a predetermined incident angle and totally reflects the rest as is the case with the internal reflection surface 15c.

In the 3D projector 7, an incident position of the infrared light-emitting element 17 is different from the 3D projector 1 of FIG. 1. The infrared light-emitting element 17 is disposed on the side of the outgoing surface of the TIR prism 70 toward the projection lens 16 such that infrared light is incident on a surface of the TIR prism 70. Therefore, the incident infrared light is applied to a surface 75d other than the outgoing surface toward the projection lens 16 and the internal reflection surface 75c. Therefore, the surface 75d is subjected to total reflection coating or infrared reflection coating so as to act as an infrared reflection surface reflecting infrared light.

As depicted in FIG. 8, the 3D projector B has a TIR prism 80. The TIR prism 70 has a triangular prism 85a same as the triangular prism 15a of the TIR prism 15 of FIG. 1 and a deformed triangular prism 85b arranged oppositely, and an internal reflection surface (boundary surface) 85c thereof only allows passage of light incident at an angle smaller than a predetermined incident angle and totally reflects the rest as is the case with the internal reflection surface 15c.

In the 3D projector 8, an incident position of the infrared light-emitting element 17 is different from the 3D projector 1 of FIG. 1. In the 3D projector 8, the triangular prism 85b is provided with a surface parallel to the incident surface of the triangular prism 85a from the DMD 14 such that the infrared light-emitting element 17 disposed on the side of the surface makes infrared light incident on the surface. The triangular prism 85b is provided with an oblique surface 85d subjected to infrared reflection coating and acting as an infrared reflection surface so as to prevent the incident infrared light from going through the outgoing surface toward the projection lens 16. The oblique surface 85d is formed at an angle such that the infrared light reflected by the oblique surface 85d is reflected by the internal reflection surface 85c and directed to the projection lens 16.

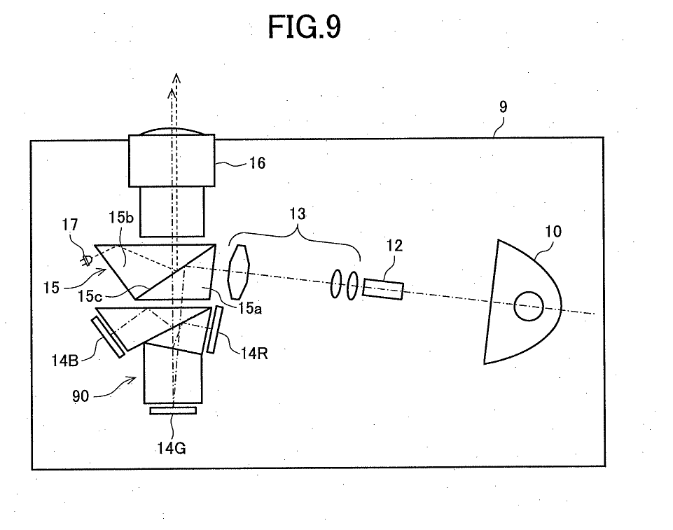

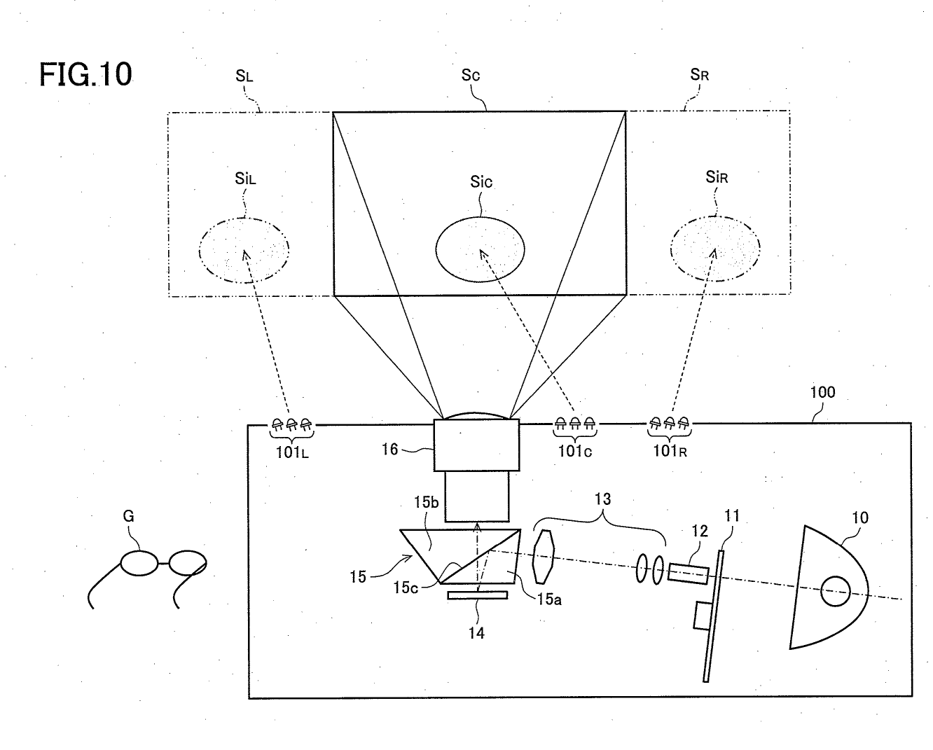

The projection display device according to the present invention is not limited to the exemplary configurations of FIGS. 1, 7, and 8 and, for example, an exemplary configuration as depicted in FIG. 9 is also employable. FIG. 9 is a schematic of a further exemplary configuration of the projection display device according to the present invention and, in FIG. 9, a reference numeral 9 denotes a 3D projector.

The 3D projector 9 is an apparatus including three DMDs, i.e., a green DMD 14_{G}, a red DMD 14_{R}, and a blue DMD 14_{B}, and a Philips type dichroic prism 90 that is a tricolor separation/composition prism. The 3D projector 9 is configured such that the infrared light emitted from the infrared light-emitting element 17 is incident on a surface not used for video in the TIR prism 15 as is the case with the 3D projector 1 of FIG. 1.

The 3D projector 9 separates the incident light into R, G, and B with the dichroic prism 90 and controls the DMDs 14_{G}, 14R_{R}, and 14B_{B}, with a control portion not depicted such that color images are reflected, recombined by the dichroic prism 90, and emitted via the TIR prism 15 and the projection lens 16 toward the screen. Therefore, the 3D projector 9 does not need to be provided with the color wheel 11 unlike the 3D projector 1 of FIG. 1. The other portions of the 3D projector 9 same as the 3D projector 1 will not be described.

Although an example of employing infrared light has been described above, however, the case of using ultraviolet light or visible light instead of infrared light will be described. Even in the case of using ultraviolet light or visible light, the present invention is basically applicable as is the case with infrared light and produces the same effects. Therefore, in the case of ultraviolet light or visible light, a light beam projected from the projection lens 16 and reflected by a projected surface, i.e., the screen S, is usable in the same way for opening and closing the active shutters of the active-shutter three-dimensional image viewing glasses.

An internal reflection surface of a TIR prism in the case of emitting ultraviolet light from a light-emitting element will supplementarily be described. In this case also, ultraviolet light is reflected as depicted in the frequency characteristics of reflectance of glass with a normal antireflection film for visible light applied in the graph 61 of FIG. 6. Describing in terms of the exemplary configuration of FIG. 1, the optical system as described in FIG. 1 can be established by only applying a normal antireflection film for visible light to the internal reflection surface 15c. Even when ultraviolet light is employed, the antireflection film applied to the internal reflection surface 15c acts as a reflection film for the emitted ultraviolet light and, preferably, the antireflection film is configured to increase the reflectance for the emitted ultraviolet light, i.e., the antireflection film is a film having a capability of increasing the reflectance for the emitted infrared light.

An internal reflection surface of a TIR prism in the case of emitting visible light from a light-emitting element will supplementarily be described. If visible light is emitted from the light-emitting element, the visible light is not reflected as depicted in the frequency characteristics of reflectance of glass with a normal antireflection film for visible light applied in the graph 61 of FIG. 6. Therefore, describing in terms of the exemplary configuration of FIG. 1, the optical system as described in FIG. 1 cannot be established by only applying a normal antireflection film for visible light to the internal reflection surface 15c.

In this case, the antireflection film applied to the internal reflection surface 15c must be configured to act as a reflection film for the visible light emitted from the light-emitting element, i.e., such that an antireflection film is employed that reflects only a wavelength band emitted from the light-emitting element out of visible light. In the case of such a configuration, it is concerned that a light beam of video in the wavelength band is also not projected to the screen S; however, the effect on the video can be reduced by extremely narrowing the wavelength band (and by driving the light-emitting element to emit visible light in a band having a lower usage frequency).

Although the light beam transmission such as infrared transmission in the present invention is described on the premise that a light beam is used for opening and closing the active shutters of the active-shutter glasses in the description, a light beam such as infrared light can also be utilized for another purpose such as focus adjustment at the time of zooming of the projection lens 16 or the light beam transmission such as infrared transmission in the present invention can be configured to be utilized only for another purpose such as focus adjustment without using the light beam transmission for opening and closing the active shutters. Describing the exemplary configuration of FIG. 1 as a supplement to the focus adjustment, for example, a light receiving element receiving infrared light may be disposed at the position of the infrared light-emitting element 17 or in the vicinity thereof and the spread of the infrared light may be detected with the light receiving element based on the intensity of the infrared light to perform the focus adjustment based on the detection result.

A specific example of the light-emitting element will be described. A light-emitting diode is employable for the infrared light-emitting element 17. The costs of the 3D projector 1 can be reduced by employing a common inexpensive light-emitting diode for the infrared light-emitting element 17. The infrared light-emitting element 17 may be a laser element. Since a laser element has an extremely small numerical aperture (NA), efficient projection can be performed without the effect of an aperture of the projection lens 16. In the case of employing ultraviolet light or visible light instead of infrared light, a light-emitting diode or a laser element is also employable for the light-emitting element.

A half-value angle of the infrared light-emitting element 17 will be described. A typical F-value is basically F2.5 (i.e., NA=0.2). On the other hand, for example, a shell type light-emitting diode having a half-value angle of about 10 degrees is readily available. NA=0.2 corresponds to an effective capturing angle of sin⁻¹(NA)=11.5 degrees and basically matches the half-value angle. The light from a light-emitting diode can efficiently be projected to a screen by employing an infrared light-emitting element having a half-value angle corresponding to the effective capturing angle indicated by the F-value of the projection lens 16. In the case of employing ultraviolet light or visible light instead of infrared light, it is also preferable to employ a half-value angle corresponding to the effective capturing angle indicated by the F-value of the projection lens 16 as a half-value angle of the light-emitting element.

Although the projection display device according to the present invention has been described in terms of an apparatus displaying video by using a reflective mirror array element, the same function can be achieved even in an apparatus employing another optical system not using a mirror array element, for example, a liquid crystal projector if a total internal reflection prism is added to employ the arrangement of the light-emitting element described above.

A projection display device not using a mirror array element includes a total internal reflection prism having two prisms arranged oppositely and a projection lens, and is an apparatus capable of displaying three-dimensional images by causing the light emitted from a light source to be projected via the total internal reflection prism from the projection lens.

Describing an exemplary configuration not using a mirror array element by taking a liquid crystal projector as an example with reference to the exemplary configuration of FIG. 1, the DMD 14 may be removed such that a light source passing through a liquid crystal displaying element is incident on the surface of the TIR prism 15 on the side disposed with the DMD 14. Alternatively, the DMD 14 may be removed from the exemplary configuration of FIG. 1 and a liquid crystal displaying element is disposed before the TIR prism 15 (e.g., between the condenser lens 13 and the TIR prism 15) such that light is totally reflected by the surface of the TIR prism 15 depicted on the side of the DMD 14. In either case, the light-emitting element is preferably disposed relative to the TIR prism 15 such that a light beam such as infrared light is incident on a surface different from the incident surface of the light emitted from the light source (light source passing through liquid crystal) and the outgoing surface toward the projection lens 16. However, the light beam such as infrared light may be incident on the outgoing surface toward the projection lens 16 as is the case with the exemplary configuration of FIG. 7.

### EXPLANATIONS OF LETTERS OR NUMERALS

1, 7, 8, 9 . . . 3D projector; 10 . . . light source device; 11 . . . color wheel; 12 . . . rod integrator; 13 . . . condenser lens; 14 . . . DMD; 14_{B} . . . blue DMD; 14_{G} . . . green DMD; 14_{R} . . . red DMD; 15, 70, 80 . . . TIR prism; 15a, 15b, 75a, 75b, 85a, 85b . . . triangular prism; 15c, 75c, 85c . . . internal reflection surface (boundary surface); 16 . . . projection lens; 17 . . . infrared light-emitting element; 43 . . . condenser lens; 44 . . . DMD; 46 . . . projection lens; 61, 62 . . . characteristic graph; 75d . . . surface; 85d . . . oblique surface; and 90 . . . dichroic prism.

1-11. (canceled)

12. A projection display device capable of displaying three-dimensional images comprising: a total internal reflection prism having two prisms arranged oppositely; a projection lens; a light-emitting element; and a reflective mirror array element, the projection display device causing light emitted from a light source to be projected via the reflective mirror array element and the total internal reflection prism from the projection lens,
the light-emitting element being disposed to make a light beam incident on the total internal reflection prism such that the light beam is reflected by an internal reflection surface of the total internal reflection prism and projected via the projection lens,
the light-emitting element being disposed relative to the total internal reflection prism such that the light beam is incident on a surface different from an incident surface of the light emitted from the light source, an incident surface of the light reflected by the reflective mirror array element, and an outgoing surface toward the projection lens.

13. The projection display device as defined in claim 12, wherein the light-emitting element is a light-emitting diode.

14. The projection display device as defined in claim 12, wherein the light-emitting element is a laser element.

15. The projection display device as defined in claim 12, wherein the light-emitting element has a half-value angle corresponding to an effective capture angle indicted by an F-value of the projection lens.

16. The projection display device as defined in claim 12, wherein the light beam projected from the projection lens and reflected by a projected surface is used for opening and closing active shutters in active-shutter three-dimensional image viewing glasses.

17. The projection display device as defined in claim 12, wherein the light-emitting element is an infrared light-emitting element or an ultraviolet light-emitting element, and wherein the total internal reflection prism has an antireflection film for visible light disposed on the internal reflection surface.

18. A projection display device capable of displaying three-dimensional images comprising: a total internal reflection prism having two prisms arranged oppositely; a projection lens; and a light-emitting element, the projection display device causing light emitted from a light source to be projected via the total internal reflection prism from the projection lens,
the light-emitting element being disposed to make a light beam incident on the total internal reflection prism such that the light beam is reflected by an internal reflection surface of the total internal reflection prism and projected via the projection lens,
the light-emitting element having a half-value angle corresponding to an effective capture angle indicted by an F-value of the projection lens.

19. A projection display device capable of displaying three-dimensional images comprising: a total internal reflection prism having two prisms arranged oppositely; a projection lens; and a light-emitting element, the projection display device causing light emitted from a light source to be projected via the total internal reflection prism from the projection lens,
the light-emitting element being disposed to make a light beam incident on the total internal reflection prism such that the light beam is reflected by an internal reflection surface of the total internal reflection prism and projected via the projection lens,
the light beam projected from the projection lens and reflected by a projected surface is used for opening and closing active shutters in active-shutter three-dimensional image viewing glasses.

20. A projection display device capable of displaying three-dimensional images comprising: a total internal reflection prism having two prisms arranged oppositely; a projection lens; and a light-emitting element that is an infrared light-emitting element or an ultraviolet light-emitting element, the projection display device causing light emitted from a light source to be projected via the total internal reflection prism from the projection lens,
the light-emitting element being disposed to make a light beam incident on the total internal reflection prism such that the light beam is reflected by an internal reflection surface of the total internal reflection prism and projected via the projection lens,
the total internal reflection prism having an antireflection film for visible light disposed on the internal reflection surface.

21. The projection display device as defined in claim 18, wherein the light-emitting element is disposed relative to the total internal reflection prism such that the light beam is incident on a surface different from an incident surface of the light emitted from the light source and an outgoing surface toward the projection lens.

22. The projection display device as defined in claim 18, further comprising a reflective mirror array element, wherein the light emitted from the light source is projected via the reflective mirror array element and the total internal reflection prism from the projection lens, and wherein
the light-emitting element is disposed relative to the total internal reflection prism such that the light beam is incident on a surface different from an incident surface of the light emitted from the light source, an incident surface of the light reflected by the reflective mirror array element, and an outgoing surface toward the projection lens.

23. The projection display device as defined in claim 19, wherein the light-emitting element is disposed relative to the total internal reflection prism such that the light beam is incident on a surface different from an incident surface of the light emitted from the light source and an outgoing surface toward the projection lens.

24. The projection display device as defined in claim 19, further comprising a reflective mirror array element, wherein the light emitted from the light source is projected via the reflective mirror array element and the total internal reflection prism from the projection lens, and wherein
the light-emitting element is disposed relative to the total internal reflection prism such that the light beam is incident on a surface different from an incident surface of the light emitted from the light source, an incident surface of the light reflected by the reflective mirror array element, and an outgoing surface toward the projection lens.

25. The projection display device as defined in claim 20, wherein the light-emitting element is disposed relative to the total internal reflection prism such that the light beam is incident on a surface different from an incident surface of the light emitted from the light source and an outgoing surface toward the projection lens.

26. The projection display device as defined in claim 20, further comprising a reflective mirror array element, wherein the light emitted from the light source is projected via the reflective mirror array element and the total internal reflection prism from the projection lens, and wherein
the light-emitting element is disposed relative to the total internal reflection prism such that the light beam is incident on a surface different from an incident surface of the light emitted from the light source, an incident surface of the light reflected by the reflective mirror array element, and an outgoing surface toward the projection lens.
